(19) United States
(12) Patent Application Publication
(10) Pub. No.: US 2014/0313045 A1
(43) Pub. Date: Oct. 23, 2014

(54) ORIENTATION DETECTION MODULE AND DISPLAY

(71) Applicant: Jay Leboff, Bedford, NY (US)

(72) Inventor: Jay Leboff, Bedford, NY (US)

(21) Appl. No.: 13/865,479

(22) Filed: Apr. 18, 2013

(51) Int. Cl. G08B 21/18

(52) U.S. Cl. CPC G08B 21/182
USPC 340/689

(57) ABSTRACT

A system that includes a sensor module and a display module configured to receive information from the sensor module regarding the orientation of the sensor module, and configured to display the information regarding the orientation of the sensor module relative to a reference position.

### FIELD OF THE INVENTION

The present invention relates to a system for acquiring and reporting information relating to the orientation of an object.

### BACKGROUND

In many applications, it is desirable to maintain the alignment of a moving object along a desired path. For example, when using a hand tool, such as a saw, it is desirable to ensure that the saw remains aligned along a predetermined plane until the cutting of the work piece is completed in order to get a good cut.

It is known that in applications involving a moving object misalignment of the object during movement is possible. Thus, using the hand saw example, after the hand saw is properly aligned with the work piece, during the subsequent cutting, variations in the pitch, the roll and the yaw can cause the hand saw to deviate from its original path thus resulting in the improper cutting of the work piece.

To properly align a tool along a desired path, U.S. Pat. No. 7,121,358 proposes sensing the angular orientation of the tool and at least its pitch and yaw.

It is also known that deviation from a desired path can be measured. U.S. Pat. Nos. 3,521,227 and 4,702,257 disclose devices that measure the pitch, the roll and the yaw for that purpose.

### SUMMARY OF THE INVENTION

An object of the present invention is to provide information about the change in the orientation of an object relative to a reference orientation.

A system according to the present invention includes a sensor module, and a display module in communication with the sensor module. The sensor module includes a sensor circuit that collects information relating to the spatial orientation of the sensor module, and transmits the information so collected to the display module.

The display module includes a receiver that receives the information sent by the sensor module and a microprocessor that is configured (i.e. programmed) to interpret the information received from the sensor module and to operate a display device that reports the information in a human perceptible form (e.g. visually).

According to one aspect of the present invention, the microprocessor is configured to record information defining a reference position upon receiving a proper command from the sensor module. The information about the reference position is then used by the programmed microprocessor to determine and report deviations from the reference position.

In the preferred embodiment, the information relating to the reference position is recorded in an electronic memory device residing in the display module. Preferably, the command for recording the information relating to the memory device is sent from the sensor module upon manual actuation of a set button residing on the sensor module.

The sensor module in the preferred embodiment includes a sensor circuit that includes a level sensor, a pitch sensor, a roll sensor, and a yaw sensor. Preferably, all sensors are MEMS devices, e.g. accelerometers.

The sensor module may further include a wireless transmitter, a charging circuit, a rechargeable battery, and a processor, which is programmed to receive and format the output of the sensor devices for transmission to the display module by the wireless transmitter. Preferably, a common circuit board supports all the sensors, the wireless transmitter, the charging circuit, the rechargeable battery, and the processor.

The display module in a system according to the present invention includes a microprocessor, a memory device, a display driver, and a display device. The microprocessor and the memory device may be copackaged, defined in a common microchip, or be separately packaged devices. The display module may further include a wireless receiver, a charging circuit and a rechargeable battery.

In the preferred embodiment, the sensor module and the display module are wirelessly connected. In its preferred form, a display module is at least capable of displaying information about the yaw, the roll and the pitch of the sensor module, and preferably the level status (orientation of the sensor module relative to the horizon) of the sensor module with a level display. The level display may be used by the user to orient the sensor module relative to the horizon. Thus, a user may reorient the object to which a sensor module is attached until the desired orientation is reached, and then the set command may be sent to the display module in order to define and record the reference position.

In use, a sensor module according to the present invention is preferably mounted to an object and is not moved while in operation. According to an aspect of the present invention, a sensor mount that is configured for mounting to an object is configured to securely receive a sensor module of a system according to the present invention.

Advantageously, the nature of an object or article to which the sensor module may be attached or at which it may be positioned is unlimited. Since the sensor module is reporting information relating to its own orientation, the sensor module, when attached, can be used to report information about the orientation of any object. For example, a sensor module according to the present invention may be attached to a hand saw. Once the saw is aligned as desired, by sending a set command to the display module, a reference position is defined and recorded by the display module. As the saw is moved by the user, the display module visually reports any deviation from the reference position to the user so that the user may make appropriate corrections in order to ensure that the saw remains aligned with the reference position.

As another example, a plurality of sensor modules can be attached to a patient's limb at different positions prior to surgery (e.g. an orthopedic operation) to record the original position of the patient's limb prior to the operation. Each sensor module may be associated with a respective display module, or a single display module that is associated with a plurality of sensor modules may report the orientation of each sensor module relative to its reference position. After the operation, the patient's limb may be returned to its position prior to the operation by repositioning the patient's limb until all sensor modules have returned to a position coinciding with their respective reference positions.

As yet another example, in aviation, or on a surface transport or on any type of machinery, a system according to the present invention may be employed to sense and display roll, pitch and yaw.

Preferably, the information provided by the display module is in visual form, although audible devices (e.g. a buzzer or the like) may be used to report deviation from the reference position.

Other features and advantages of the present invention will become apparent from the following description of the invention which refers to the accompanying drawings.

### BRIEF DESCRIPTION OF THE DRAWINGS

FIG. 1 schematically illustrates a system according to the present invention.

FIG. 2A illustrates a top perspective view of a sensor module according to the present invention.

FIG. 2B illustrates a top perspective view of a sensor module according to the present invention without a cover.

FIG. 2C illustrates a cross-sectional view along line 2C-2C viewed in the direction of the arrows.

FIG. 2D illustrates a cross-sectional view along line 2D-2D viewed in the direction of the arrows.

FIG. 3A illustrates a top perspective view of a display module according to the present invention.

FIG. 3B illustrates a top perspective view of a sensor module according to the present invention with the cover and the display device thereof removed from view.

FIG. 3C illustrates a cross-sectional view along line 3C-3C viewed in the direction of the arrows.

FIG. 3D illustrates a cross-sectional view along line 3D-3D viewed in the direction of the arrows.

FIG. 3E illustrates a top perspective view of a display device of a display module according to the present invention.

FIG. 4A illustrates a perspective view of a display scheme according to a second embodiment of the present invention.

FIG. 4B illustrates a plan view of a display scheme according to a third embodiment of the present invention.

FIG. 4C illustrates a plan view of a display scheme according to a fourth embodiment of the present invention.

FIG. 5 illustrates a sensor module, a display module and charging station according to an embodiment of the present invention.

FIG. 6 illustrates a top plan view of a sensor mount for receiving and mounting a sensor module according to the present invention.

FIG. 7 illustrates a front plan view of a sensor module received in the sensor mount illustrated in FIG. 6.

FIG. 8 illustrates a side plan view of a sensor mount with an adhesive backing.

FIG. 9 illustrates a side plan view of a sensor mount with a clip according to a first configuration.

FIG. 10 illustrates a side plan view of a sensor mouth with a clip according to a second configuration.

FIG. 11 illustrates a side plan view of a sensor mount with a strip receiver for receiving a strip or the like.

### DETAILED DESCRIPTION OF EMBODIMENTS OF THE INVENTION

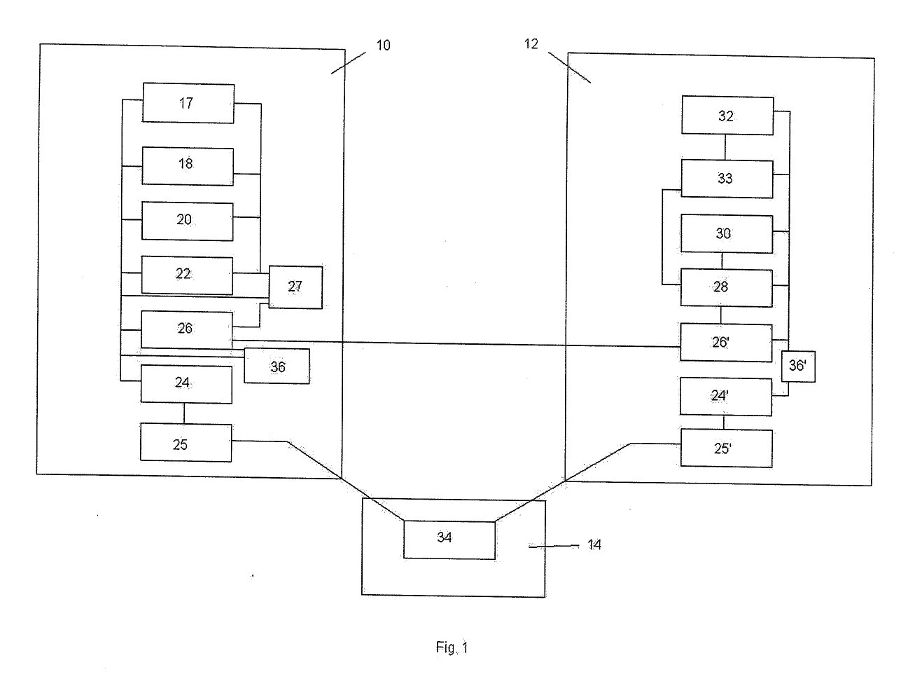

Referring to FIG. 1, a system according to the first embodiment of the present invention includes a sensor module 10, a display module 12, and preferably a charging station 14.

Sensor module 10 includes a sensor circuit that preferably includes, a level sensor 17, a yaw sensor 18, a pitch sensor 20, and a roll sensor 22, all MEMS-based devices. In the preferred embodiment, the MEMS-based device are accelerometers.

Sensor module 10 may further include a rechargeable battery 24, a charger circuit 25 and a wireless transmitter 26, which are packaged in the same package with the sensor circuit. In one configuration, wireless transmitter 26, the sensor circuit and battery 24 reside on a common circuit board as further disclosed below. A microprocessor 27 is provided in module 10 and programmed to receive and convert the raw output from sensors 17, 18, 20, 22 and to relay the converted output of sensors 17, 18, 20, 22 to wireless transmitter 26 for transmission. Module 10 further includes a power ON/OFF button 36, which serves as a reset button when module 10 is in its ON state.

Display module 12 includes a microprocessor 28, an electronic memory 30, a display driver 33, and a display device 32. Display module 12 may further include a rechargeable battery 24′, a charger circuit 25′ and a wireless receiver 26′. Note that memory 30 and microprocessor 28 may be separately packaged, copackaged, or defined in the same chip and packaged. Display module 12 may further include a power ON/OFF button 36′ which may also serve as a reset button, when module 12 is in its ON state.

Microprocessor 28, display driver 33, wireless receiver 26′, battery 24′, charger circuit 25′ and button 36′ may all reside on one common circuit board as further disclosed below, while display device 32 may reside on another circuit board as will be further disclosed below.

Charging station 14 includes a converter 34 that converts AC power to DC power. Charging station 14 may be equipped with means (e.g. ordinary AC plugs) for connection with a conventional AC power outlet, and also connectors for detachable connection with sensor module 10 and display module 12 to supply power to charge rechargeable batteries 24, 24′.

Transmitter 26 and receiver 26′ of sensor module 10 and display module 12 are configured to be in wireless communication with one another when modules 10, 12 are in the ON state, whereby data and command, may be communicated between the two modules wirelessly. Wireless communication may be based on Bluetooth or XBEE protocols. Batteries 24, 24′ may be lithium-polymer batteries and are respective sources of power in each module 10, 12 (i.e. batteries 24, 24′ supply power to the components of the modules). Note that while rechargeable batteries are preferred, ordinary batteries may be used without deviating from the scope and spirit of the present invention, in which case no charging station 14 is necessary.

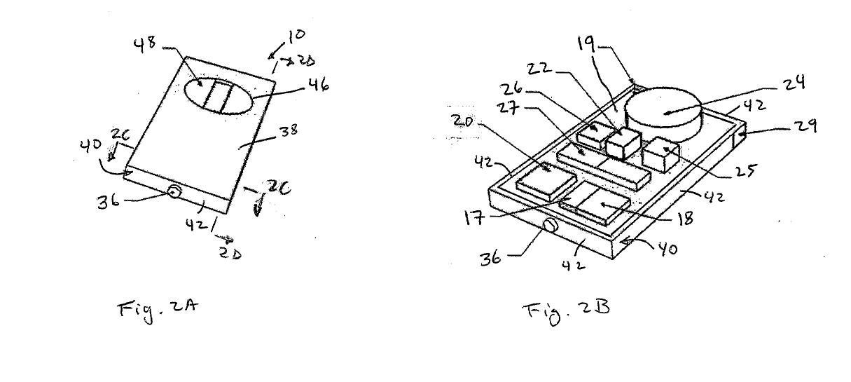

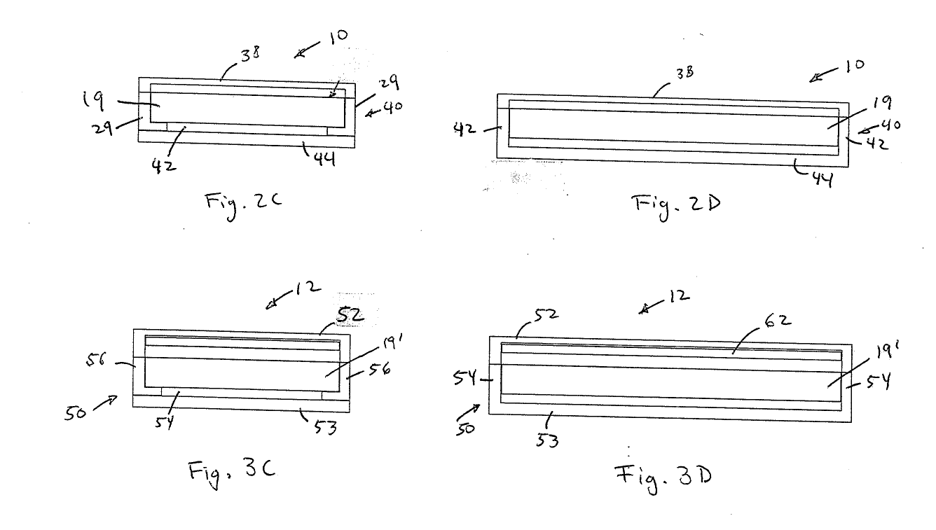

Referring to FIGS. 2A, 2B, 2C, and 2D, a sensor module 10 in its preferred form includes a housing, preferably in rectangular form, which includes a cover 38 and a base 40. Base 40 includes four sidewalls 42, each pair of sidewalls 42 being parallel to one another and intersecting the other pair of parallel sidewalls. Sidewalls 42 extend upwardly away from edges of rectangular planar base wall 44. Sidewalls 42 and base wall 44 define a base 40 in which a circuit board 19 is received. Circuit board 19 provides support for level sensor 17, yaw sensor 18, pitch sensor 20, roll sensor 22, processor 27, wireless transmitter 26, charger circuit 25 and battery 24. In addition, circuit board 19 includes the proper conductive traces to connect level sensor 17, yaw sensor 18, pitch sensor 20, roll sensor 22, processor 27, wireless transmitter 26 and battery 24 whereby power may be supplied to these components, appropriate conductive traces to connect battery 24 to charger circuit 25, and appropriate conductive traces to connect level sensor 17, yaw sensor 18, pitch sensor 20, and roll sensor 22 to processor 27 and processor 27 to wireless transmitter 26. Button 36 is connected via appropriate conductive traces on circuit board 19 to turn the power ON/OFF and to provide the necessary signal to transmit a set signal via wireless transmitter 26 to wireless receiver 26′.

In its preferred form, circuit board 19 is a planar body and is installed within base 40 parallel to base wall 44 of base 40. ON/OFF button 36, is preferably installed on circuit board 19 and emerges through one of sidewalls 42 of base 40. Power contacts 29, which are connected to charger circuit 25 via appropriate conductive traces on circuit board 19, preferably reside at opposite edges of circuit board 19 and emerge through opposing, parallel sidewalls 42 and are exposed to make contact with corresponding power input contacts of charging station 14 as will be further disclosed below. Note that, preferably, power contacts 29 reside at bottom corners of base 40.

Cover 38 is fitted over and coupled to base 40 to realize the enclosure that encloses circuit board 19 and the components that are supported by circuit board 19. Cover 38 preferably includes an access port 46 defined therein to allow access to battery 24. Battery 24 may be received and replaced through port 46 without opening the enclosure by removing cover 38. Access port 46 preferably includes a removable cover 48, which can be screwed into port 46 or snapped into port 46.

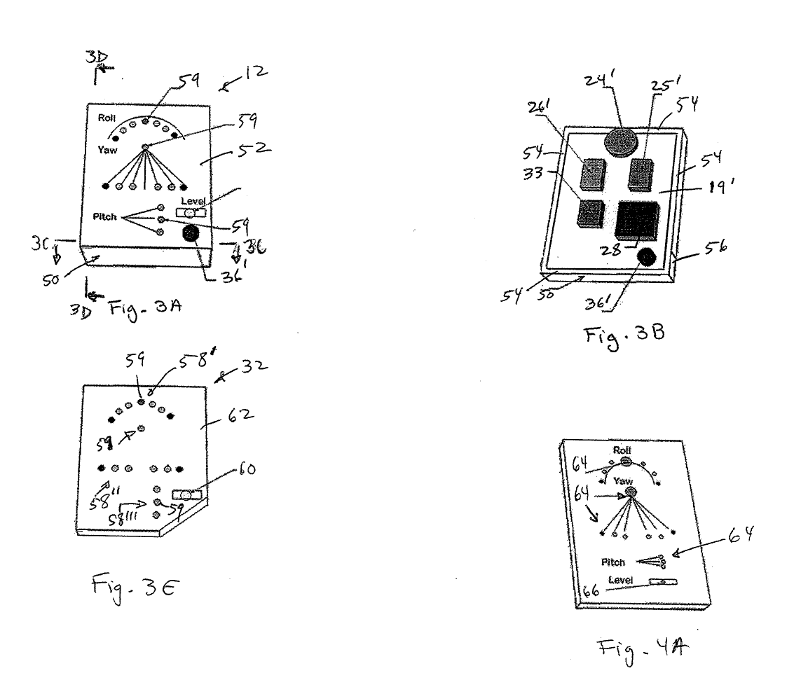

Referring now to FIGS. 3A, 3B, 3C, 3D and 3E, a display module 12 in its preferred form includes an enclosure having a base 50 and a cover 52. Base 50 includes a rectangular and preferably planar bottom base wall 53 and four sidewalls 54 extending upwardly from edges of base wall 53. Sidewalls 54 include two pairs of parallel sidewalls, each pair intersecting the other pair of parallel sidewalls. A circuit board 19′ is received inside of base 50. Circuit board 19′ supports microprocessor 28, charger circuit 25′, battery 24′, wireless receiver 26′, display driver 33, and ON/OFF button 36′, and includes appropriate conductive traces thereon to connect charger circuit 25′ to battery 24′, to connect battery 24′ to microprocessor 28 (and memory device 30 if provided separately), wireless receiver 26′, and display driver 33, and to connect microprocessor 28 to display driver 33 and to connect microprocessor 28 to memory device 30, when memory device 30 is provided as an independent component.

Power contacts 56 are preferably supported on opposite edges of circuit board 19′, connected via appropriate conductive traces on circuit board 19′ to charger circuit 25′, and each is exposed through a respective sidewall 54 for contact with corresponding power input contacts of charging station 14 as further disclosed below. Note that, preferably, power contacts 56 reside at bottom corners of base 50.

Referring to FIG. 3E, a display device 32 in the preferred embodiment includes a plurality of LEDs 58,59 and a level display 60 (e.g. an LCD display) are arranged on a circuit board 62 and receive signals and power via appropriate conductive traces thereon for operation. Circuit board 62 is in communication with display driver 33 whereby, LEDs 58,59 and level display 60 can be operated as further explained below. Circuit board 62 is further connected to battery 24′.

Circuit board 62 is preferably mounted to the underside of cover 52. Cover 52 includes openings therein which register with LEDs 58, 59, an opening which registers with level display 60, and an opening that registers with ON/OFF button 36′. Through the openings, LEDs 58, and level display 60 may be visually perceived and ON/OFF button 36′ may be accessible for manual actuation/operation by a user. Note that on an exterior surface thereof, opposite the surface on which circuit board 62 is mounted, cover 52 includes labels printed thereon each label associated with and identifying a respective group of LEDs 58,59 that indicate the status of the roll, the yaw, and the pitch deviation of sensor module 10 relative to a reference position as further disclosed below. Level display 60 may also be identified with a label, which indicates the orientation of module 10 relative to the horizon. It should be noted that while in the preferred embodiment circuit board 62 is mounted to an underside surface of cover 58, it could also be mounted to, over and spaced from circuit board 19′. In either case, circuit board 62 would reside over circuit board 19′ and would be connected to receive power and other signals from circuit board 19′.

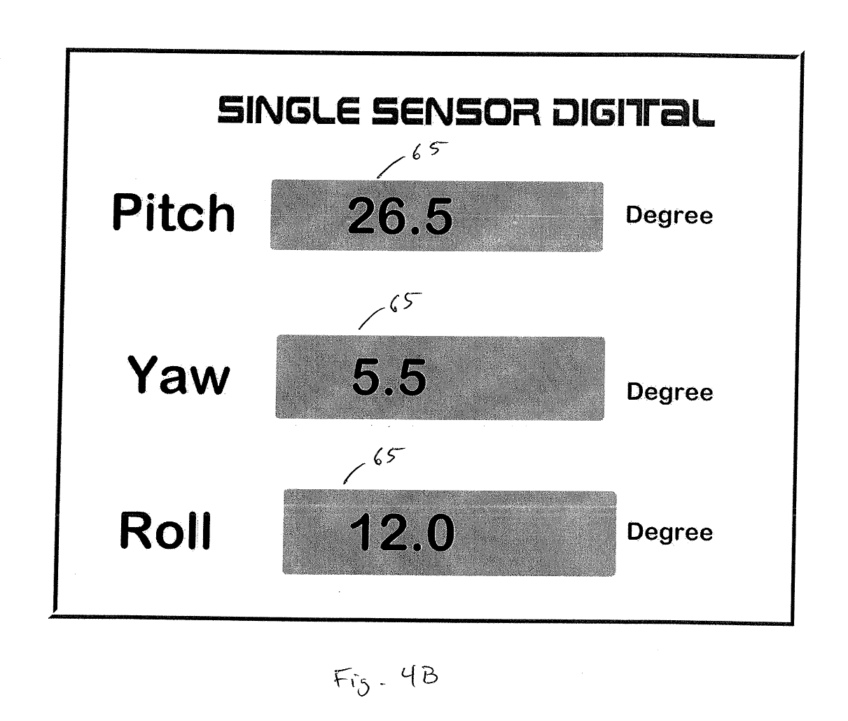

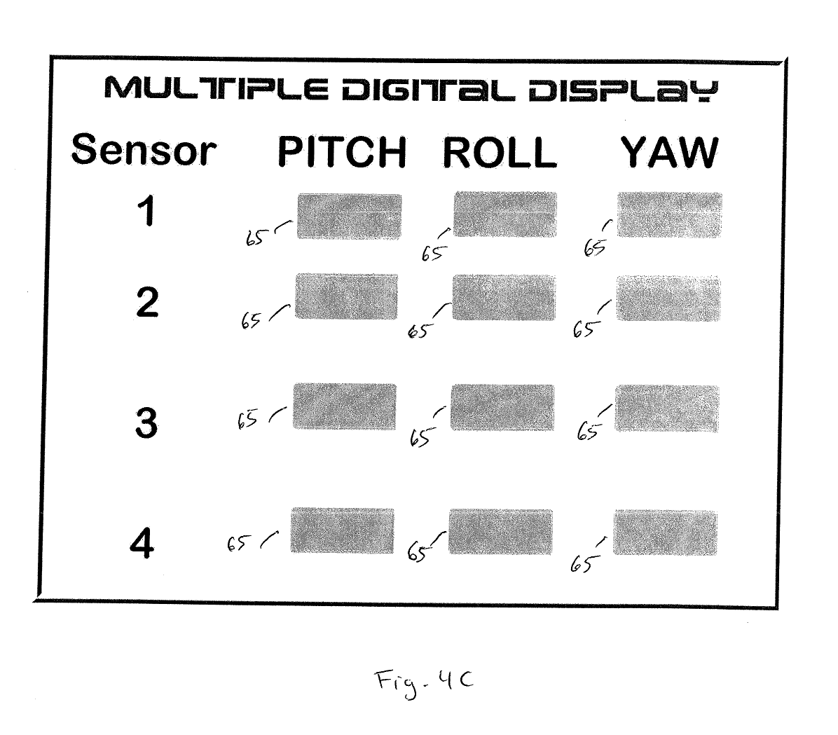

In a system according to the second embodiment of the present invention, a wireless programmable device that includes a display such as a mobile telephone, a laptop computer, or a tablet computer, can be programmed to include a display with indicators to show roll, yaw, pitch and level information in substantially the same manner as LEDs 58,59 and level display 60. For example, as shown in FIG. 4A, the display could include a plurality of spaced visual indicators 64 which would be operated to indicate variations in roll, pitch, and yaw relative to a reference position as well as an indicator 66 to indicate the orientation of module 10 relative to the horizon (level status). Indicators 64 and 66 could be arranged in the same manner as LEDs 58,59 and level display 60 and configured to emulate an LED on a conventional display (e.g. an LCD display of a computer).

Referring to FIG. 4B, according to a third embodiment, the display scheme could include a plurality of visual indicators 65 that report variations in pitch, yaw and roll relative to a reference position numerically. Visual indicators 65 may be implemented by an appropriate software coding to display numerical values on the monitor of a computer or the like general purpose device.

Referring to FIG. 4C, according to a fourth embodiment, the display scheme could include a plurality of visual indicators 65 that report variations in pitch, roll, and yaw relative to a reference plane numerically for a plurality of sensor devices. This display scheme may be most suitable for an application requiring multiple sensor modules (e.g. a surgical application as noted earlier).

In the preferred embodiment, sensors 17, 18, 20, 22 are arranged on a planar circuit board 19. Sensors 18, 20, 22 are arranged on circuit board 19 so that the axes thereof correspond to the yaw axis, the pitch axis, and the roll axis of circuit board 19. Each axis is preferably arranged to be orthogonal to the other two axes. It should be noted that while in the preferred embodiment, each sensor may be a single axis accelerometer, all three sensors 18, 20, 22 could replaced with a three-axis accelerometer.

Level sensor 17, which may also be an accelerometer, is arranged to sense the orientation of circuit board 19 relative to the horizon. For example, level sensor 17 would sense when circuit board 19 is parallel with the horizon or not. Preferably, circuit board 19 is oriented relative to the housing of module 10 so that its orientation also indicates the orientation of sensor module 10 relative to the horizon. For example, circuit board 14 may be mounted parallel to base wall 44 so that when circuit board 19 is parallel to the horizon, base wall 44 and thus module 10 will be parallel to the horizon.

Rechargeable battery 24 and transmitter 26 may be connected to circuit board 19 with appropriate connectors but need not be arranged on circuit board 19. Thus, rechargeable battery 24, transmitter 26, and circuit board 19 supporting the sensor circuit may be arranged in the same package but do not need to reside on a common circuit board.

When modules 10 and 12 are in the ON state, microprocessor 28 receives data from receiver 26′ and is programmed to process the information so that it may be displayed by display device 32. Specifically, microprocessor 28 is programmed to operate, and operates display driver 33 which drives display device 32. Note that microprocessor 28 is in communication with memory device 30 and is programmed to selectively store information therein and/or extract stored information from memory device 30. Microprocessor 28 can be one or a combination of devices that can be programmed or have been programmed with appropriate software for interpretation of data received from sensor module 10 and appropriate operation of display device 32. It should be noted that microprocessor 28 may include an internal memory for storage of data (e.g. information relating to the reference position). Such an internal memory would correspond to memory device 30 as discussed herein if it serves the functions described herein. A low-power, digital microprocessor (microcontroller) with analog and digital input/output capability and onboard memory is a suitable device for a display module according to the present invention.

In use, a user may turn sensor module 10 ON and place module 10 on an object, or sensor module 10 may be turned ON after it has been placed on the object. Preferably, module 10 is securely placed and is not removed during operation as that may adversely affect the readings obtained. Preferably, display module 12 is turned ON before module 10 is turned ON. Once sensor module 12 is turned ON, display module 12 and sensor module 10 become wirelessly linked so that display module 12 may receive data and commands from sensor module 10.

While sensor module 10 is operating, all sensors 17, 18, 20, and 22 may continuously gather information about the change in orientation of sensor module 10 relative to the horizon and output electronic signals (e.g. voltage) to processor 27. Once the user presses button 36 that is located on sensor module 10, information relating to the spatial orientation of sensor module 10 relative to the horizon at the time of actuation of button 36 is transmitted via transmitter 26 to receiver 26′ of display module 12. That is, when button 36 is actuated the readings (i.e. the output of) of sensors 18, 20, 22 as well as a set command is transmitted to receiver 26′. Microprocessor 28 is programmed to, in response to the set command, record the readings of sensors 18, 20, 22 at the time of actuation of button 36 in memory (either in the on-board memory or memory device 30 depending on the chosen configuration). The readings of sensors 18, 20, 22 at the time of actuation of button 36 indicate the orientation of circuit board 19 (as well as module 10 if circuit board 19 is parallel to planar base wall 44) relative to the horizon (e.g. celestial horizon or the rational horizon). According to one aspect of the present invention, the readings of sensors 18, 20, 22 at the time of actuation of button 36 define a reference position. A reference position as used herein means a data set that defines the orientation of module 10 relative to the horizon at the time of actuation of button 36.

Thereafter, as sensor module 10 moves, information relating to its orientation is transmitted via transmitter 26 to receiver 26′ continuously and sent to microprocessor 28. Microprocessor 28 then compares the information received to the set information stored in memory device 30 to determine deviations of sensor module 10 from the reference position. Microprocessor 28 then operates display device 32 through operation of display driver 33 to visually report the deviations of sensor module 10 from the orientation corresponding to the reference position to the user. The deviations from the reference position may be computed simply by subtracting the value of one reported data point from the value of a corresponding data point in the data set defining the reference position.

In the preferred embodiment, the deviations of sensor module 10 from the reference position are reported as pitch, roll and yaw deviations from the reference position.

Referring now to FIGS. 3A and 3E, in the first embodiment of the present invention, display device 32 includes a plurality of LEDs 58′, 58″, 58′″ which may be different colors. A first group of LEDs 58′, may be aligned along a first arcuate line spaced from one another to indicate the degree of roll, another group of LEDs 58″ may be arranged spaced from one another to include yaw, and another group of LEDs 58′″ may be arranged along another arcuate line to indicate pitch. A green LED 59 may indicate that there is no deviation from a corresponding axis in the reference position. That is, when green LED 59 is ON in the group of LEDs 58″ indicating yaw, it means that there is no deviation along the yaw axis as recorded in the data set defining the reference position. Each green LED 59 in the other two sets indicates the same information (i.e. no deviation for the corresponding roll axis or pitch axis as the case may be). LEDs to the left and to the right of a green LED 59 may be lit with LEDs of different colors indicating the degree of deviation. Thus, yellow LEDs may be used to indicate ±9°, ±18°, ±27° deviations in yaw, pitch or roll, while red LEDs may be used to indicate ±36° and ±45° deviations.

Thus, in the preferred embodiment, a green LED indicates zero deviation, yellow LEDs indicate ±9°, ±18°, ±27° deviations, and red LEDs indicate ±36° and ±45° deviations from one of the axes (roll, pitch, and yaw) of the reference position. In the preferred embodiment, once the set command is received, all green LEDs are turned ON for at least a period of time (e.g. 3 seconds or less) to indicate to the user that a reference position has been defined and recorded. Thus, the user may continue operating the device.

With the information provided by display module 12, the user can adjust the position of sensor module 10 until the desired deviation is attained, or sensor module 10 is realigned to coincide with its position when button 36 was actuated. For example, sensor module 10 is moved until the green LEDs 59 light up indicating zero yaw, zero pitch and zero roll deviations relative to the reference position. Level display 60 allows the user to level the object to which module 10 is attached before button 36 is actuated.

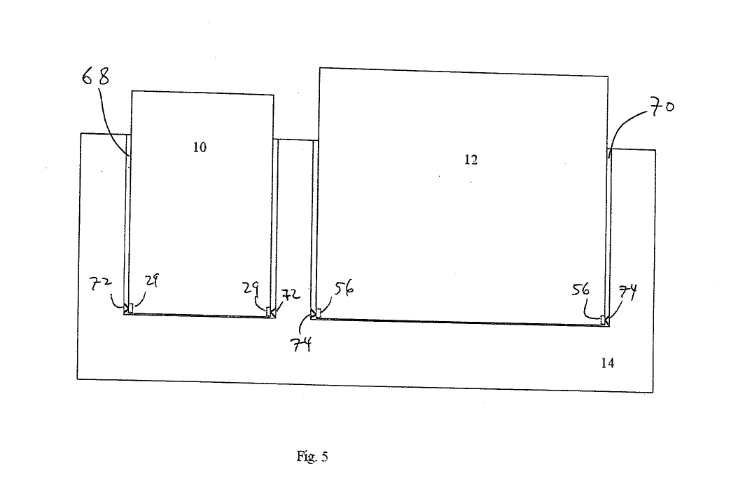

Referring to FIG. 5, a physical manifestation of a system as shown in FIG. 1 is illustrated. Thus, as illustrated, a system according to the first embodiment includes a charging station 14. Charging station 14 includes two cradles 68, 70. Cradle 68 is configured to receive sensor module 10 and includes power contacts 72 each configured to make contact with a respective contact 29 of module 10, whereby power is supplied to charger circuit 25. Cradle 70 is configured to receive display module 12 and includes power contacts 74 each configured to make contact with a respective contact 56 of module 12, whereby power may be supplied to charger circuit 25′ of display module 12.

Referring to FIG. 6 and FIG. 7, a sensor mount 71 may be used to mount sensor module 10 to a surface. Sensor mount 71 may include a pocket 73 in which sensor module 10 is securely received. Alternatively, sensor module 10 may include on opposite sides thereof respective spring-loaded snaps, each snap located at an end of a leaf spring that is secured to sensor module 10. Each snap may be receivable in a respective recess defined inside pocket of sensor mount. Thus, once fully received inside, sensor module 10 is secured inside sensor mount 71. Each snap may be associated with a respective manual actuator. Sensor module 10 can be withdrawn from pocket by manually pressing actuators toward each other thereby releasing snaps from recesses.

Sensor mount 71 may be then mounted adhesively or the like to a surface, thereby aligning sensor module 10 to the surface on which sensor mount is mounted. Thus, sensor mount 71 may be provided with an adhesive backing 76 so that it may be adhesively mounted to a flat surface. Adhesive backing 76 may be any geometric shape such as rectangular or circular shape and need not be confined to the boundaries of sensor mount 71 (e.g. may be a long strip that can be adhered to curved surfaces).

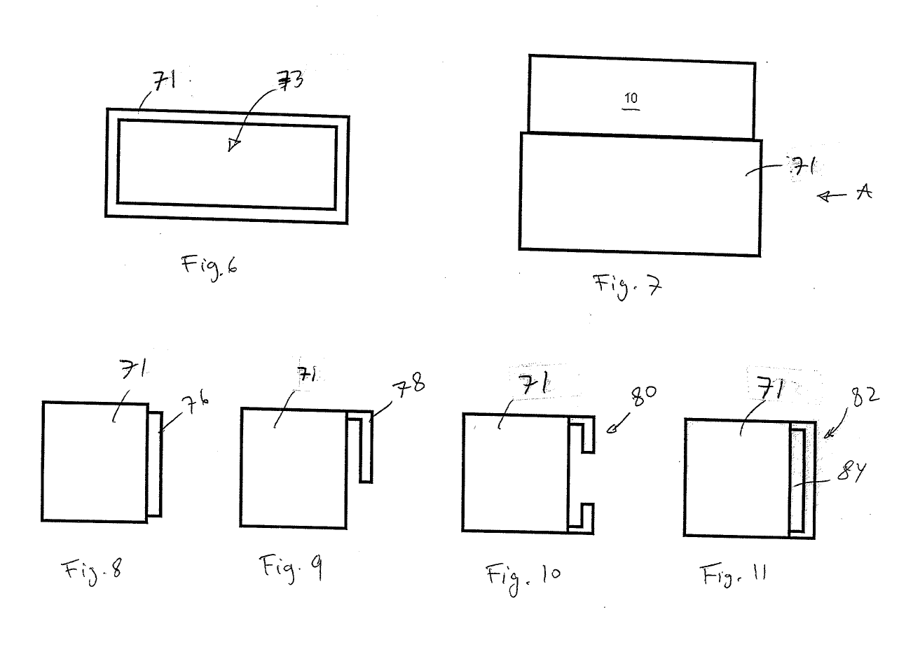

Sensor mount 71 could also be provided with a mounting clip 78 or the like as illustrated in FIG. 9. Thus, for example, sensor mount may be clipped to a saw blade or the like body.

Sensor mount 71 may also be provided with a C-shaped clip 80 having a mouth sized to securely receive a hacksaw blade or the like body as illustrated in FIG. 10. Adhesive or the like may be applied between sensor mount 71 and the hacksaw blade for further stability.

As illustrated in FIG. 11, the gap in the C-shaped clip 80 may be closed to define a strap receiver that defines an elongated slot 84 through which a strap could be received to secure sensor mount 71 to a body (e.g. a person's limb, a pipe etc.).

It should be noted that although FIGS. 6-11 show methods of securing a sensor mount to a surface, all methods disclosed could be used to secure a sensor module 10 to a surface directly without the need for a sensor mount 71. However, a sensor mount 71 is preferred since several sensor mounts could be secured to several different surfaces (e.g. on different tools) and only one sensor module 10 could be used with all sensor mounts.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A spatial orientation indication system, comprising:
a sensor module that includes a transmitter, and a sensor circuit that senses variations in spatial orientation of said sensor module and provides information indicative of said variations in spatial orientation to said transmitter;
a display module that includes a receiver configured to receive said information from said transmitter, a display device, and a microprocessor that receives said information from said receiver and operates said display device to indicate variations in orientation of said sensor module relative to a reference position.

2. The system of claim 1, wherein said microprocessor is configured to define said reference position responsive to receiving a set command from said sensor module.

3. The system of claim 1, wherein said display module displays at least variations in pitch, roll and yaw.

4. The system of claim 1, wherein said sensor module and said display module are configured to be in wireless communication.

5. The system of claim 1, wherein said sensor module and said display module are battery powered.

6. The system of claim 1, wherein said sensor module and said display module are powered with rechargeable batteries and further comprising a charger configured to charge said rechargeable batteries.

7. The system of claim 1, wherein said display device comprises a first group of LEDs, a second group of LEDs, and a third group of LEDs, the first group of LEDs being arranged along a first line, the second group of LEDs being arranged along a second line, and the third group of LEDs being arranged along a third line.

8. The system of claim 7, wherein said third line is arcuate.

9. The system of claim 1, wherein said sensor circuit includes a plurality of MEMS-based sensor devices.

10. The system of claim 9, wherein said MEMS-based sensor devices comprise a pitch sensor, a roll sensor, and a yaw sensor.

11. The system of claim 10, wherein said MEMS-based sensor devices further comprise a level sensor.

12. The system of claim 1, further comprising a sensor mount configured for mounting to an object and configured for securely receiving said sensor module.

13. The system of claim 12, wherein said sensor mount includes a clip.

14. A method of reporting variation in spatial orientation, comprising:
sensing a first spatial orientation of an object;
transmitting information indicative of said first spatial orientation along with a set command;
defining a reference position based on said information indicative of said first spatial orientation;
recording said information defining said reference position;
sensing a second spatial orientation of said object;
transmitting information indicative of said second spatial orientation;
determining deviation of said object from said first spatial orientation based on said information indicative of said second spatial orientation and said reference position; and
controlling a device to report deviation of said object from said first spatial orientation.

15. The method of claim 14, wherein said device is a display device.

16. The method of claim 15, wherein said display device includes indicators that display deviations in yaw, roll and pitch.

17. The method of claim 16, wherein each said indicator includes a plurality of spaced LEDs, and further comprising operating one or more LEDs in response to a deviation from said first spatial orientation to indicate deviation from said first spatial orientation.

18. The method of claim 14, wherein said information is transmitted wirelessly.

19. The method of claim 14, wherein MEMS devices are used for sensing said spatial orientation.

20. The method of claim 18, wherein said MEMS devices include a pitch sensor, a roll sensor and a yaw sensor.
